(19) United States
(12) Patent Application Publication
(10) Pub. No.: US 2009/0153471 A1
(43) Pub. Date: Jun. 18, 2009

(54) Apparatus and method for inputting characters

(75) Inventor: Dong Hoon Lee, Yongin-si (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/231,259

(22) Filed: Aug. 29, 2008

(30) Foreign Application Priority Data
Dec. 17, 2007 (KR) 10-2007-0132835

(51) Int. Cl. G09G 5/00

(52) U.S. Cl. 345/156

(57) ABSTRACT

The present invention provides an apparatus and method for inputting characters, which allow various characters to be inputted to a multimedia device. The character input apparatus preferably includes a user manipulation unit for generating one or more stroke signals and/or one or more arc signals, and a character detection unit for detecting one or more characters using the stroke signals and/or the arc signals. The stroke signals and/or the arc signals are signals corresponding to strokes and/or arcs constituting respective characters, and the characters are data about the characters including the strokes and/or the arcs corresponding to the stroke signals and/or the arc signals.

### CROSS-REFERENCE TO RELATED APPLICATIONS

This application claims under 35 U.S.C. §119(a) priority to Korean Application No. 10-2007-0132835, filed on Dec. 17, 2007, the disclosure of which is incorporated herein by reference in its entirety.

### BACKGROUND

1. Technical Field

The present invention relates, in general, to an interface for inputting data to a device and, more particularly, to a character input apparatus and method for inputting characters.

2. Background Art

In order to input characters to multimedia devices or navigation devices, a user must select and input respective characters on a one-character-at-a-time basis through the interface of the device in question. In order to input various characters, respective switches for generating signals corresponding to respective characters are required, or, alternatively, various characters must be displayed on the screen to allow a user to select desired characters. Accordingly, the space occupied by the interface of the relevant device increases. Further, the user suffers the inconvenience of checking and selecting desired characters whenever respective characters are input, and the user requires a predetermined amount of time to become accustomed to a character input method for a given interface.

Attempts have been made to recognize characters using methods of generating various combinations of signals by manipulating a small number of switches and mapping respective characters to the combinations of respective signals; however it is difficult to increase the number of pieces of data that can be generated due to the limitations of an input device (for example, the number of switches, etc.). Further, conditional rules are designated depending on the limited conditions of a relevant interface rather than the users convenience, so that a predetermined time is required for the user to become accustomed to the designated rules.

Therefore, an interface allowing various characters to be generated using a small number of pieces of unit data, facilitating the generation of a large number of characters, and allowing a user to easily manipulate the interface is urgently required.

The above information disclosed in this the Background section is only for enhancement of understanding of the background of the invention and therefore it may contain information that does not form the prior art that is already known in this country to a person of ordinary skill in the art.

### SUMMARY OF DISCLOSURE

An object of the present invention is to provide an apparatus and method for inputting characters, which can facilitate input of various characters to a device.

Another object of the present invention is to provide an apparatus and method for inputting characters, which can facilitate input of characters using a method of inputting strokes and arcs according to a users usual writing habit.

In accordance with an aspect of the present invention, there is provided a character input apparatus for inputting various characters. In certain embodiments, the character input apparatus comprises a user manipulation unit for generating one or more stroke signals or one or more arc signals and a character detection unit for detecting one or more characters using the stroke signals or the arc signals. In certain suitable embodiments, the character input apparatus comprises a user manipulation unit for generating one or more stroke signals and/or one or more arc signals; and a character detection unit for detecting one or more characters using the stroke signals and/or the arc signals, wherein the stroke signals and/or the arc signals are signals for strokes and/or arcs, constituting respective characters, and the characters are data about characters including strokes and/or arcs corresponding to the stroke signals and/or the arc signals.

In accordance with another aspect of the present invention, there is provided a character input method, comprising generating one or more stroke signals and/or one or more arc signals; detecting one or more characters corresponding to the stroke signals and/or the arc signals; and displaying the detected characters on a screen, wherein the stroke signals and/or the arc signals are signals for strokes and/or arcs constituting respective characters, and the characters are data about the characters including the strokes and/or the arcs corresponding to the stroke signals and/or the arc signals.

In accordance with a further preferred aspect of the present invention, there is provided a character setting method, comprising selecting a character to be set; receiving one or more stroke signals and/or one or more arc signals corresponding to the character; and storing the character, the stroke signals and/or the arc signals corresponding to the character, and information about an input sequence of the stroke signals and/or the arc signals.

Input devices and methods of the invention may be suitably used for various devices having a multimedia function, including, but not limited to, mobile communication terminals, an MP3 player, a Personal Digital Assistant (PDA), and a navigation device. Such devices and methods suitably can be employed in a motor vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the state in which a typical English capital letter is broken down into one or more strokes and/or one or more arcs to describe the principle by which characters are input according to the present invention.

FIG. 2 is a diagram showing the construction of a character input apparatus for inputting characters according to the present invention.

FIG. 3 is a diagram showing a jog dial used as a user manipulation unit according to an embodiment of the present invention.

FIG. 4A to FIG. 4E are tables showing methods of manipulating the jog dial of FIG. 3 to input stroke and arc data according to the present invention.

FIG. 5A to FIG. 5D are tables showing the operation sequence to input English letters ‘A’ to ‘Z’ using the jog dial according to the present invention.

FIG. 6 is a flowchart showing a method of inputting characters using the character input apparatus according to the present invention.

FIG. 7 is a flowchart showing a method in which a user sets one or more stroke signals and/or one or more arc signals corresponding to respective characters and information about the input sequence of the stroke signals and/or the arc signals according to the present invention.

### DETAILED DESCRIPTION

As described herein, the invention features in a preferred aspect character input apparatus for inputting characters. In preferred embodiments, the character input apparatus suitably comprises a user manipulation unit for generating one or more stroke signals or one or more arc signals and a character detection unit for suitably detecting one or more characters using the stroke signals or the arc signals.

In certain preferred embodiments of the character input apparatus, the stroke signals or the arc signals are preferably signals for strokes or arcs, comprising respective characters, and the characters are data about characters including strokes or arcs preferably corresponding to the stroke signals or the arc signals.

In other preferred embodiments of the character input apparatus, the character detection unit preferably uses information about an input sequence of the stroke signals or the arc signals, together with the stroke signals or the arc signals, in order to detect the characters.

This input apparatus may preferably be used for various devices having a multimedia function, including, but not limited to, mobile communication terminals, an MP3 player, a Personal Digital Assistant (PDA), and a navigation device.

Hereinafter, embodiments of an apparatus and method for inputting characters according to the present invention will be described in detail with reference to the attached drawings.

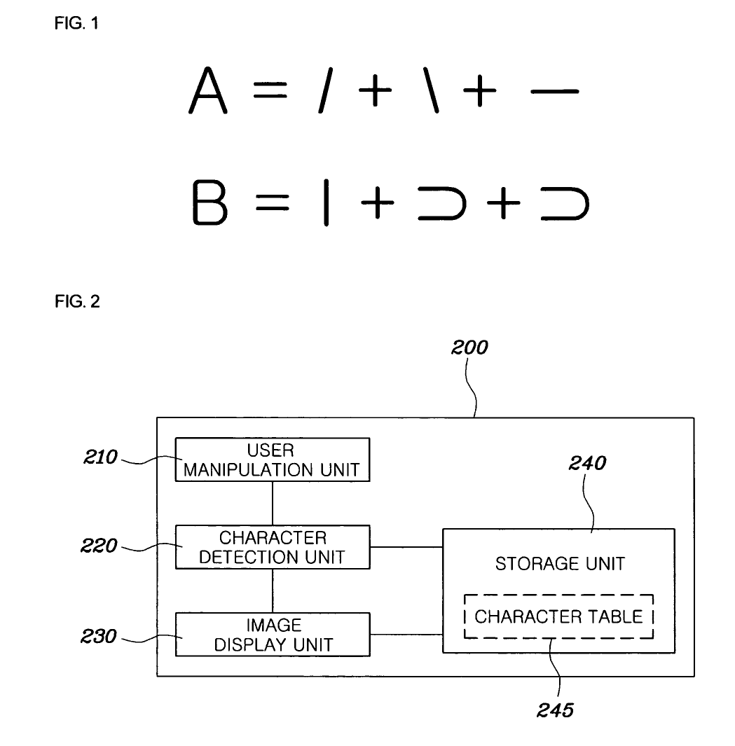

FIG. 1 is an exemplary diagram showing the state in which a typical English capital letter is preferably broken down into one or more strokes and/or one or more arcs to suitably describe the principle by which characters are input.

According to certain suitable embodiments, characters are represented by one or more strokes and/or one or more arcs. For example, an English capital letter ‘A’ is suitably composed of three strokes ‘/’, ‘\’, and ‘—’. Further, an English capital letter ‘B’ is composed of a single stroke ‘|’ and two arcs ‘⊃’. Similarly, all English characters ranging from capital letters ‘A’ to ‘Z’ can be suitably broken down into one or more strokes and/or one or more arcs.

In this case, since the types of strokes and arcs used to represent respective characters are suitably limited, and all characters are composed of different combinations of strokes and/or arcs, it is possible to generate or identify respective characters using preferable combinations of a small number of pieces of data when data about strokes and data about arcs are used. That is, when a character is input to a multimedia device, each character can be recognized using a method of sequentially inputting signals for one or more strokes and/or one or more arcs preferably constituting a single character.

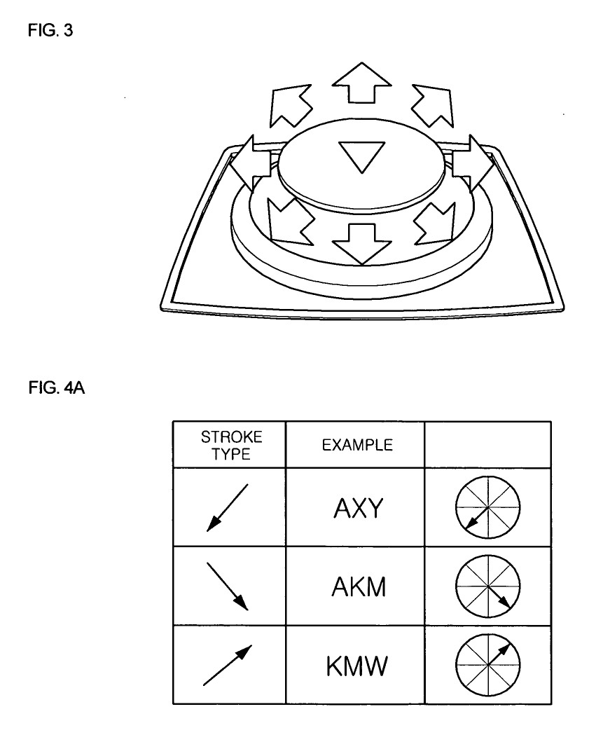

FIG. 2 is a diagram showing the suitable construction of a character input apparatus 200 for inputting characters according to the present invention. In certain preferred embodiments, this input apparatus may be used for various devices having a multimedia function, such as, but not limited to a mobile communication terminal, an MP3 player, a Personal Digital Assistant (PDA), and a navigation device. Further, the preferred character input apparatus 200 according to the present invention may be an element of the multimedia device, or may be suitably provided separately from the multimedia device.

Referring to FIG. 2, the suitable character input apparatus 200 according to the present invention can include in exemplary embodiments, a user manipulation unit 210 and a character detection unit 220.

The user manipulation unit 210 is preferably a portion provided to allow the user to input desired strokes and arcs, and suitably configured to generate signals for respective strokes and arcs, for example, stroke signals and arc signals according to the manipulation of the user. When respective strokes and arcs are input, the user can suitably manipulate the user manipulation unit 210 in a method similar to a method of writing respective strokes and arcs. In certain preferred embodiments, a description will be made using a jog dial as the user manipulation unit 210. In preferred embodiments, a joystick may be used instead of the jog dial and the jog dial has function of the joystick.

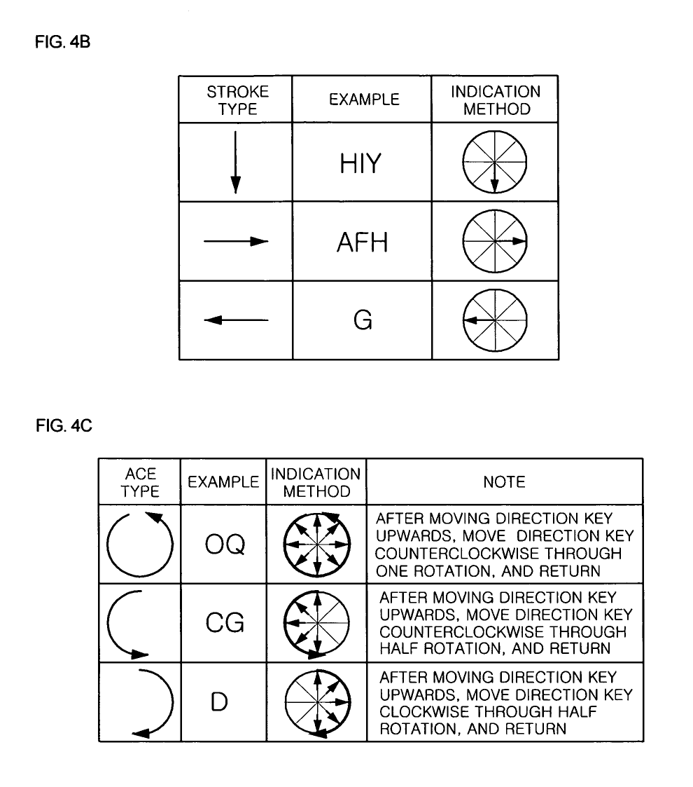

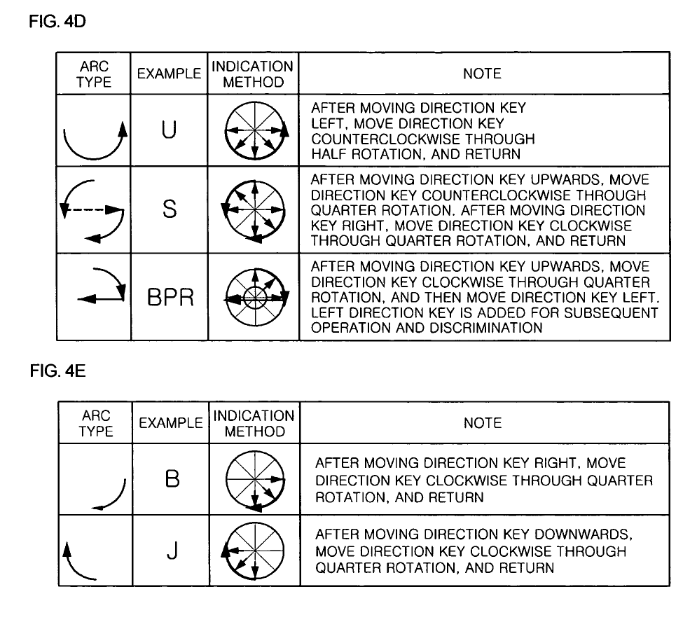

An example of the above-described jog dial is shown in FIG. 3, and FIG. 4A to 4E are tables showing methods of manipulating the jog dial of FIG. 3 to input stroke data and arc data according to the present invention.

Referring to FIG. 3, the jog dial is suitably configured to operate eight switches, which are provided below the jog dial, by pressing or tilting the jog dial in upward/downward/left/right directions (↑, ↓, ←, →) and four diagonal directions ( [symbol] ). A User may suitably input a stroke using the jog dial. For example, when inputting the first stroke ‘/’ of a capital letter ‘A’, the user suitably presses or tilts the jog dial for indicating the lower left diagonal direction, that is, the direction of [symbol] . Further, when inputting the second stroke ‘\’ of the capital letter ‘A’, the user suitably presses or tilts the jog dial for indicating the lower right diagonal direction, that is, the direction of [symbol] .

Further, when inputting a semicircular arc, such as a capital letter ‘C’, the user can input the semicircular arc by suitably rotating the jog dial counterclockwise in such a way as to sequentially operate the switches, ranging from the upward switch to the downward switch, counterclockwise.

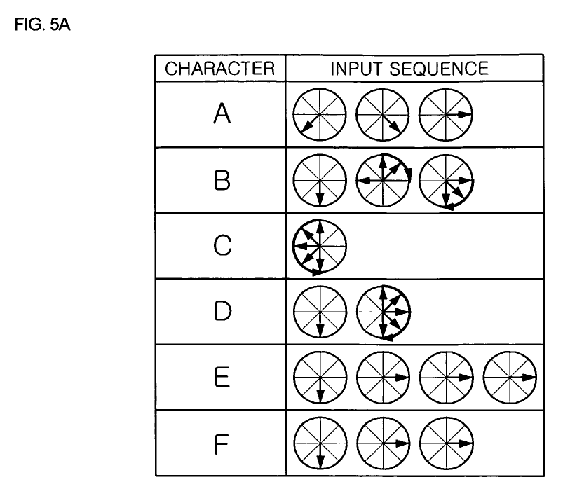

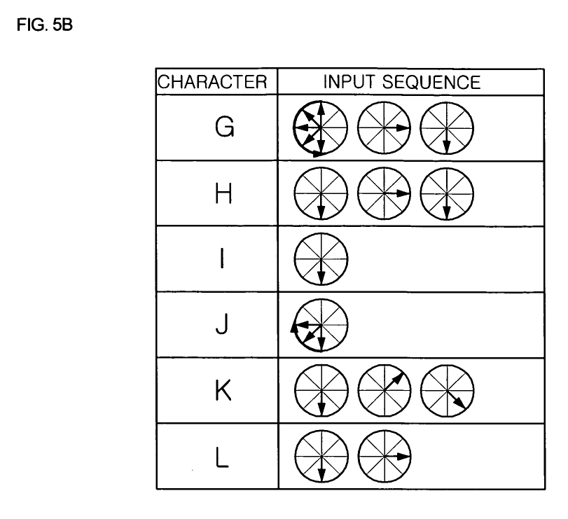

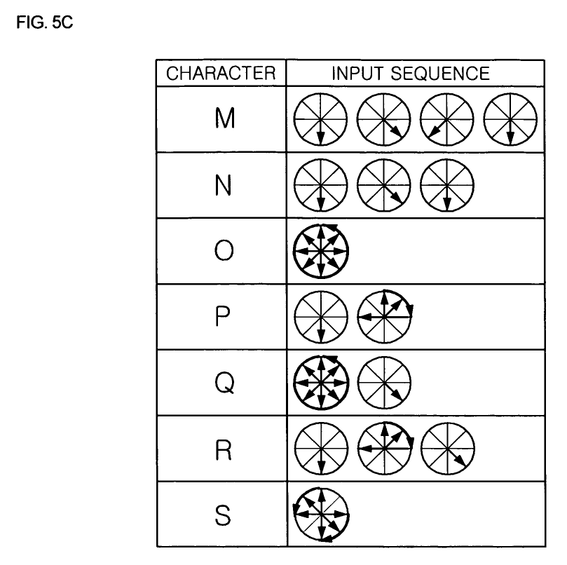

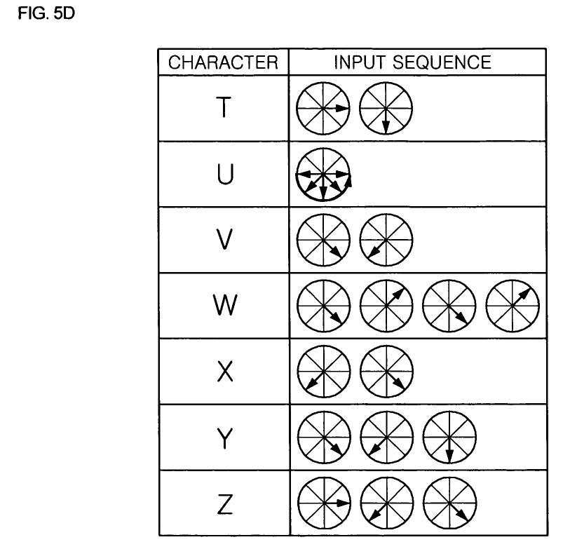

In addition to the above examples, the direction in which the jog dial is manipulated to input various strokes and arcs, and the switches, operated by the jog dial, are shown in the tables of FIG. 4A to FIG. 4E. Examples of suitable characters to which strokes are applied, but not only limited only to these characters, are shown in the tables of FIG. 4A and FIG. 4B. Examples of suitable characters to which arcs are applied, but limited only to these characters, are shown in the tables of FIG. 4C and FIG. 4E. Further, tables, showing the operation sequence to input English letters from ‘A’ to ‘Z’ using the jog, are shown in FIG. 5A to FIG. 5D.

Referring back to FIG. 2, in certain exemplary embodiments, the character detection unit 220 receives a series of stroke signals and/or arc signals, suitably input when the user manipulates the user manipulation unit 210, and preferably detects characters corresponding to the received stroke signals and/or arc signals. In this case, the character detection unit 220 may suitable use information about the input sequence of the stroke signals and/or the arc signals, as well as the stroke signals and/or the arc signals input by the user, in order to detect the characters.

In certain embodiments, the character detection unit 220 may suitably refer to a character table 245, in which respective inputtable characters, stroke signals and/or arc signals corresponding to the characters, and information about the input sequence of stroke signals and/or arc signals are suitably associated with to each other, in order to detect characters. In certain embodiments, the character input apparatus 200 may preferably further include a storage unit 240 for storing the character table 245 therein.

Further, the character detection unit 220 can suitably detect one or more characters corresponding to a series of input stroke signals and/or arc signals without receiving a confirmation signal. For example, when a stroke signal corresponding to a stroke ‘ [symbol] ’ is suitably input by the user, the character detection unit 220 detects the characters ‘V, W, X and Y’, each preferably having the stroke ‘ [symbol] ’ as the first stroke. Next, when a stroke signal corresponding to a stroke ‘ [symbol] ’ is suitably input by the user, the character detection unit 220 detect characters ‘X and Y’, each preferably having the stroke ‘ [symbol] ’ as the first stroke and having the stroke ‘ [symbol] ’ as the second stroke. Then, when a stroke signal corresponding to the stroke ‘↓’ is suitably input by the user, the character detection unit 220 detects only the character ‘Y’, preferably having the stroke ‘ [symbol] ’ as the first stroke, the stroke ‘ [symbol] ’ as the second stroke, and the stroke ‘↓’ as the third stroke.

Further, in the jog dial, a separate confirm switch, used to generate a confirmation signal, may be provided. Thus, in certain preferred examples, the user can suitably input characters, which are detected using input stroke signals and/or arc signals, by manipulating the confirm switch after inputting a series of strokes and/or arcs. In the present embodiment, the confirm switch is suitably provided at the center portion of the jog dial, and the user can preferably manipulate the confirm switch by pressing down on the center portion of the jog dial.

In addition, in other preferred embodiments, a cancel switch used to cancel the input of strokes or arcs may be separately provided.

The character input apparatus 200 may further include an image display unit 230 for displaying stroke images and arc images corresponding to respective stroke signals and arc signals on the screen. In certain examples, the image display unit 230 can display character images corresponding to characters, detected by the character detection unit 220, together with stroke images and arc images, on the screen. The information about stroke images, arc images and character images may preferably be stored in the storage unit 240.

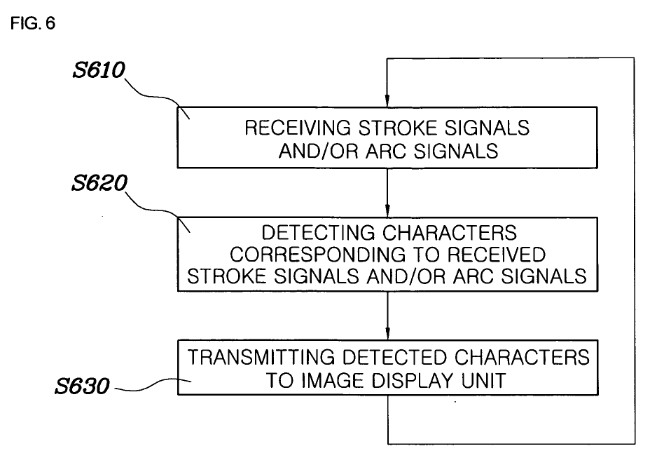

FIG. 6 is a flowchart showing an exemplary method of inputting characters using the character input apparatus 200 according to the present invention.

Referring to FIG. 6, the character input apparatus 200 suitably receives one or more stroke signals and/or one or more arc signals on a one-stroke or arc signal-at-a-time basis from the user at step S610.

At step S620, the character input apparatus 200 suitably detects one or more characters corresponding to the input stroke signals and/or arc signals. In this case, the character input apparatus 200 may preferably use information about the input sequence of the stroke signals and/or the arc signals, together with the input stroke signals and/or arc signals, in order to detect characters. Here, the character detection unit 220 can suitably detect the character with reference to the character table 245, in which respective characters, stroke signals and/or arc signals suitably corresponding to the characters, and information about the input sequence of the stroke signals and/or arc signals are associated with each other.

Further, the character input apparatus 200 can display stroke images and arc images suitably corresponding to the input stroke signals and the input arc signals on the screen. In this case, the character input apparatus 200 can display character images suitably corresponding to the characters detected by the character detection unit 220, together with the stroke images and the arc images, on the screen.

At step S630, the character input apparatus 200 preferably transmits the detected character to a image display unit in response to a received confirmation signal.

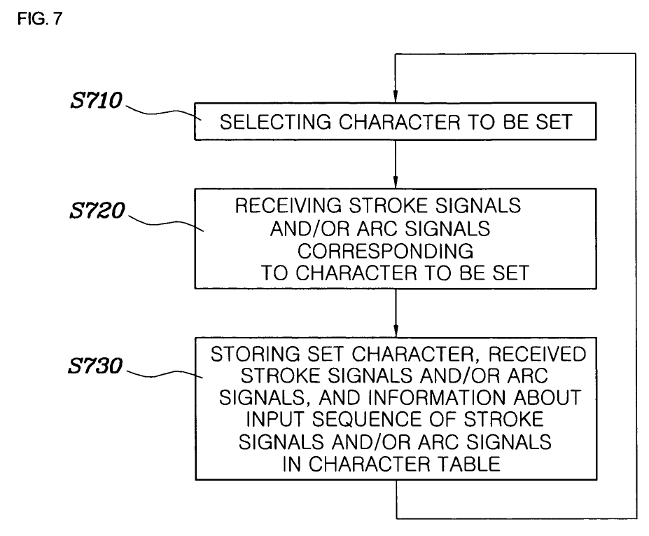

FIG. 7 is a flowchart showing an exemplary method in which a user sets one or more stroke signals and/or one or more arc signals corresponding to respective characters and information about the input sequence of the stroke signals and/or arc signals according to the present invention.

In another preferred embodiment of the present invention, the user can preset stroke signals and/or arc signals corresponding to respective characters and the input sequence of the stroke signals and/or the arc signals according to the user's usual writing habit. In this embodiment, respective characters and the information preset by the user for the characters are preferably stored in the form of the character table 245, so that the character detection unit 220 can refer to the character table 245. Further, when the character table 245 is previously stored, the above-described preset information may be suitably stored using a method of revising the character table 245.

In a preferred embodiment, referring to FIG. 7, at step S710, the character to be set is selected by the user.

At step S720, the character input apparatus 200 suitably receives one or more stroke signals and/or one or more arc signals from the user on a one-stroke or arc signal-at-a-time basis.

At step S730, the character input apparatus 200 preferably stores the character, which is set in response to a received confirmation signal, the input stroke signals and/or the input arc signals, and information about the input sequence of the stroke signals and/or the arc signals, in the character table 245.

Here, the character input apparatus 200 can suitably display character images corresponding to the set characters, and stroke images and arc images suitably corresponding to the input stroke signals and the input arc signals on the screen.

As described above, the apparatus and method according to the present invention are advantageous in that various characters can be easily input.

Further, the apparatus and method for inputting characters according to the present invention are advantageous in that characters can be input using a method of inputting strokes and arcs according to a users usual writing habit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A character input apparatus for inputting characters, comprising:
a user manipulation unit for generating one or more stroke signals and/or one or more arc signals; and
a character detection unit for detecting one or more characters using the stroke signals and/or the arc signals,
wherein the stroke signals and/or the arc signals are signals for strokes and/or arcs, constituting respective characters, and the characters are data about characters including strokes and/or arcs corresponding to the stroke signals and/or the arc signals.

2. The character input apparatus according to claim 1, wherein the character detection unit uses information about an input sequence of the stroke signals and/or the arc signals, together with the stroke signals and/or the arc signals, in order to detect the characters.

3. The character input apparatus according to claim 2, further comprising a storage unit for storing a character table in which respective characters, the stroke signals and/or the arc signals corresponding to the characters, and the information about the input sequence of the stroke signals and/or the arc signals are included,
wherein the character detection unit detects one or more characters corresponding to the stroke signals and/or the arc signals with reference to the character table.

4. The character input apparatus according to claim 1, wherein the characters, the stroke signals and/or the arc signals corresponding to the characters, and information about an input sequence of the stroke signals and/or the arc signals are preset by a user.

5. The character input apparatus according to claim 1, further comprising:
a storage unit for storing stroke images, arc images and character images corresponding to the stroke signals, the arc signals and the characters; and
an image display unit for displaying the stroke images, the arc images, and the character images.

6. The character input apparatus according to claim 1, wherein the user manipulation unit comprises eight switches configured to generate stroke signals corresponding to strokes respectively indicating upward/downward/left/right directions and four diagonal directions.

7. A character input method of inputting characters using a character input apparatus, comprising:
generating one or more stroke signals and/or one or more arc signals;
detecting one or more characters corresponding to the stroke signals and/or the arc signals;
displaying the detected characters on a screen; and
wherein the stroke signals and/or the arc signals are signals for strokes and/or arcs constituting respective characters, and the characters are data about the characters including the strokes and/or the arcs corresponding to the stroke signals and/or the arc signals.

8. The character input method according to claim 7, wherein the character input apparatus detects one or more characters using information about an input sequence of the stroke signals and/or the arc signals, together with the stroke signals and/or the arc signals.

9. The character input method according to claim 8, wherein the detecting the characters is performed with reference to a character table in which respective characters, stroke signals and/or arc signals corresponding to the characters, and information about the input sequence of the stroke signals and/or the arc signals are included.

10. The character input method according to claim 8, wherein stroke images and/or arc images corresponding to the generated stroke signals and/or arc signals, or character images corresponding to the detected characters are displayed on the screen.

11. A character setting method of setting one or more stroke signals and/or one or more arc signals corresponding to respective characters and information about an input sequence of the stroke signals and/or the arc signals using a character input apparatus, comprising:
selecting a character to be set;
receiving one or more stroke signals and/or one or more arc signals corresponding to the character; and
storing the character, the stroke signals and/or the arc signals corresponding to the character, and information about an input sequence of the stroke signals and/or the arc signals.

12. The character setting method according to claim 11, wherein the character input apparatus displays a character image corresponding to the character, and stroke images and/or arc images corresponding to the stroke signals and/or the arc signals on a screen.

13. A character input apparatus for inputting characters, comprising:
a user manipulation unit for generating one or more stroke signals or one or more arc signals; and
a character detection unit for detecting one or more characters using the stroke signals or the arc signals.

14. The character input apparatus of claim 13, wherein the stroke signals or the arc signals are signals for strokes or arcs, comprising respective characters, and the characters are data about characters including strokes or arcs corresponding to the stroke signals or the arc signals.

15. The character input apparatus according to claim 13, wherein the character detection unit uses information about an input sequence of the stroke signals or the arc signals, together with the stroke signals or the arc signals, in order to detect the characters.
